(19) United States
(12) Patent Application Publication
(10) Pub. No.: US 2005/0091299 A1
(43) Pub. Date: Apr. 28, 2005

(54) Carry look-ahead adder having a reduced area

(76) Inventors: Haeng Seok Ko, Taejon (KR); Kyoung Son Jhang, Taejon (KR); Oh Seok Kwon, Taejon (KR)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/740,444

(22) Filed: Dec. 22, 2003

(30) Foreign Application Priority Data
Oct. 28, 2003 (KR) 2003-75541

(51) Int. Cl. G06F 7/50

(52) U.S. Cl. 708/710

(57) ABSTRACT

The present invention relates to a carry look-ahead adder. The carry look-ahead adder is configured in 4-bit units in general. Each 4-bt carry look-ahead adder is combined with a carry look-ahead generating unit to constitute a carry look-ahead adder that can process input signals of larger size. The carry look-ahead adder according to the embodiment of the present invention calculates carry of each bit sequentially not by using any carry generation function or any carry propagation function but by using previous bit when generating an internal carry in the adder, so that propagation delay is allowed a little but the logic gate circuit can be simplified.

### BACKGROUND OF THE INVENITON

1. Field of the Invention

The present invention relates to a carry look-ahead adder having a reduced area, and more particularly, to a carry look-ahead adder having a reduced overall area when the carry look-ahead adder is materialized by a logic gate circuit.

2. Description of the Related Art

Generally, a high speed adder is the most basic and important operation processor used in subtraction, multiplication and division as well as addition in a digital system. Since the performance of a numerical operation processor such as a digital signal processor (DSP) or a central processing unit (CPU) depends on that of adders very much, a high speed adder has been studied since 1950.

A carry propagation adder (also called as a ripple carry adder) used widely as an adder has simple structure and occupies small area when configured as a logic gate circuit but is very slow in operation due to carry propagation delay. The carry propagation adder that can process an input of n bits is configured of n full adders connected in cascade. As the number of bits of an input signal processed by the adder increases, the operation time of the full adders increases linearly due to the carry propagation delay of each of the full-adders. To overcome the carry propagation delay problem of the carry propagation adder, a high speed adder using a method of calculating both carry and sum simultaneously is suggested.

A conditional sum adder is an adder that can be implemented with a small number of gate elements. The conditional sum adder obtains sum by using carry generation condition. An n-bit adder requires log₂ n steps for arithmetic operation. A carry-select adder is configured to select one of the sums of adders of a predetermined size that use ‘0’ and ‘1’ as a carry input respectively according to previous carry. The carry-select adder includes carry propagation adders of double size, a multiplexer and a carry selector. A carry look-ahead adder is configured to obtain carry of each bit as first carry so that carries are not propagated and the sum of bit value and carry is obtained.

Referring to the attached drawings, a general 16-bit adder will be described.

A general carry look-ahead adder calculates carry beforehand using inputted data so that an add operation result is outputted almost simultaneously and delay time is also reduced. A carry look-ahead adder consists of a block of performing add operation and a block of calculating carry. If an input is given, the carry calculation bock calculates carries of stages and transfers the carry to the add operation block. The add operation block performs add operation by using the calculated carry and obtains the sum.

Such a carry look-ahead adder uses a carry generation function and a carry propagation function so as to calculate carry beforehand. When the add operation is performed on the nth numbers X and Y, the sum Sᵢ and the carry Cᵢ are represented as Equation 1.

Equation 1
Sᵢ=(Xᵢ⊙Yᵢ)Cᵢ₋₁
Cᵢ=(Xᵢ·Yᵢ+(Xᵢ⊙Yᵢ)·Cᵢ₋₁
where “⊙” is defined as exclusive OR in this specification.

The i-th carry generation function Gᵢ and a carry propagation function Pᵢ are defined as Equation 2.

Equation 2
Gᵢ=Xᵢ·Yᵢ
Pᵢ=Xᵢ⊙Yᵢ

The carry generation function Gᵢ and the carry propagation function Pᵢ obtained by the Equation 2 are substituted into Equation 1, and the sum Sᵢ and the carry Cᵢ can be represented as Equation 3.

Equation 3
Sᵢ=Pᵢ⊙Cᵢ₋₁
Cᵢ=Gᵢ+Pᵢ·Cᵢ₋₁

If integers i from 0 to (n−1) (i=0, . . . , n−1) are substituted into Equation 3, Equation 4 can be obtained.

$$\begin{matrix}{C}_{0} = {G}_{0} + {C}_{- 1} \cdot {P}_{0} \\ {C}_{1} = {G}_{1} + {C}_{0} \cdot {P}_{1} \\ = {G}_{1} + {G}_{0} \cdot {P}_{1} + {C}_{- 1} \cdot {P}_{0} \cdot {P}_{1} \\ {C}_{2} = {G}_{2} + {C}_{1} \cdot {P}_{2} \\ = {G}_{2} + {G}_{1} \cdot {P}_{2} + {G}_{0} \cdot {P}_{1} \cdot {P}_{2} + {C}_{- 1} \cdot {P}_{0} \cdot {P}_{1} \cdot {P}_{2} \\ ⋮ \\ {C}_{n - 1} = {G}_{n - 1} + {G}_{n - 2} \cdot {P}_{n - 1} + … + {C}_{- 1} \cdot {P}_{0} \cdot {P}_{1} \cdot … \cdot {P}_{n - 1}\end{matrix} \qquad Equation 4$$

In Equation 4, since the carry Cᵢ is generated using the carry C₋ᵢ obtained at the previous stage, the carry generation function Gi that can be obtained from the two inputs Xᵢ and Yᵢ and the carry propagation function Pi and the carry can be obtained when the sum is obtained, the carry look-ahead adder does not cause delay due to carry propagation in contrast to a general adder.

FIG. 1 illustrates an overall circuit of a general 16-bit carry look-ahead adder. The 16-bit carry look-ahead adder includes four 4-bit carry look-ahead adders 10, 20, 30 and 40 and a carry look-ahead generating unit 50. If the four 4-bit adders are used for 16-bit add operation as described above and the number of input bits increases, it is more advantageous to divide the 16-bit carry look-ahead adder into a few blocks due to the limitation of the number of inputs of the logic gate elements of the adder. The four 4-bit carry look-ahead adders 10, 20, 30 and 40 receives two input signals represented by 4 bits, performs add operation, and outputs 4-bit add operation results S₃₋₀, S₇₋₄, S₁₁₋₈ and S₁₅₋₁₂. At this time, the four 4-bit carry look-ahead adders 10, 20, 30 and 40 generate and output carry generation functions G₀*, G₁*, G₂* and G₃* and carry generation functions P₀*, P₁*, P₂* and P₃* so as to calculate initial carries C₃, C₇ and C₁₁ of the next stage. The carry look-ahead generating unit 50 receives the initial carry C1, and the carry generation functions G₀*, G₁*, G₂* and G₃* and the carry propagation functions P₀*, P₁*, P₂* and P₃* outputted from the carry look-ahead adders 10, 20, 30 and 40, and generates initial carries C₃, C₇ and C₁₁, and a carry generation function G₀** and a carry propagation functions P₀** to provide to the 16-bit adder of the next stage (if the 16-bit adder is connected as the next stage). The initial carries C₃, C₇ and C₁₁ are provided to the carry look-ahead adders 20, 30 and 40 respectively and used in add operation of the corresponding carry look-ahead adders 20, 30 and 40. Also, the initial carry C₁ that is inputted to the first 4-bit carry look-ahead adder 10 and the carry look-ahead generating unit 50 is provided from the 16-bit adder of the previous stage when the adder is a complex adder to which a plurality of 16-bit adder are connected but the initial carry C₁ is a value preset by a user when the 16-bit adder is configured separately.

The carries Cᵢ calculated in the 4-bit carry look-ahead adders 10, 20, 30 and 40, the carry generation function Gᵢ* and the carry propagation function Pᵢ* can be represented as Equation 5.

Equation 5
C₀=G₀+C₋₁·P₀
C₁=G₁+G₀·P₁+C₋₁·P₀·P₁
C₂=G₂+G₁·P₂+G₀·P₁·P₂+C₋₁·P₀·P₁·P₂
C₃=G₀*+C₋₁·P₀*
C₄=G₄+C₃·P₄
C₅=G₅+G₄·P₅+C₃·P₄·P₅
C₆=G₆+G₅·P₆+G₄·P₅·P₆+C₃·P₄·P₅·P₆
C₇=G₁*+C₃·P₁*
C₈=G₈+C₇·P₈
C₉=G₉+C₈·P₉
C₁₀=G₁₀+G₉·P₁₀+G₈·P₉·P₁₀+C₇·P₈·P₉·P₁₀
C₁₁=G₂*+C₇·P₂*
C₁₂=G₁₂+C₁₁·P₁₂
C₁₃=G₁₃+G₁₂·P₁₃+C₁₁·P₁₂·P₁₃
C₁₄=G₁₄+G₁₃·P₁₄+G₁₂·P₁₃·P₁₄+C₁₁·P₁₂·P₁₃·P₁₄
Gₖ*=G₄ₖ₊₃+G₄ₖ₊₂·P₄ₖ₊₃+G₄ₖ₊₁·P₄ₖ₊₂·P₄ₖ₊₃+C₄ₖ·P₄ₖ₊₁·P₄ₖ₊₂·P₄ₖ₊₃
Pₖ*=P₄ₖ·P₄ₖ₊₁·P₄ₖ₊₂·P₄ₖ₊₃
G₀**=G₃*+G₂*·P₃*+G₁*·P₂*·P₃*+C₀*·P₁*·P₂*·P₃*
P₀**=P₀*·P₁*·P₂*·P₃*

FIG. 2 illustrates the 4-bit carry look-ahead adder 10 shown in FIG. 1 in detail. The 4-bit carry look-ahead adder 10 shown in FIG. 2 receives two input signals X₃₋₀ and Y₃₋₀ and an initial carry input C₋₁, and calculates and outputs a 4-bit sum S₃₋₀, a carry generation function G₀* and a carry propagation function P₀*. In other words, the 4-bit carry look-ahead adder 10 is configured of logic gate circuits such that can calculate the carry generation function G(3:0) and the carry propagation function P(3:0) used in the adder by using Equation 2, calculate the carries C₀, C₁ and C₂ and the carry generation function G₀* and the carry propagation function P₀* that are to be provided to the 4-bit carry look-ahead adder 20 of the next stage by using Equation 5, and calculate the 4-bit sum S₀, S₁, S₂ and S₄ by using Equation 3.

The 4-bit carry look-ahead adder 10 includes a carry generation function and carry propagation function generating unit 11, a carry generating unit 12 and an add operation unit 13.

The carry generation function and carry propagation function generating unit 11 receives 4-bit input signals X(3:0) and Y(3:0), performs AND operation and exclusive OR operation by using an AND element 111 and an exclusive OR element 112 respectively, and generates a carry generation function G(3:0) and a carry propagation function P(3:0) to be used in the carry look-ahead adder 10. The mathematical expressions of the carry generation function G₀* and a carry propagation function P₀* that are described in Equation 5 and provided to the 4-bit carry look-ahead adder 20 of the next stage are implemented by hardware such as four AND elements 113, 114, 115 and 116 and an OR element 117.

The mathematical expression of carries C₀, C₁ and C₂ represented in Equation 5 is implemented by AND elements 121, 123, 124, 126, 127 and 128 and OR elements 122, 125 and 129 of the carry generating unit 12. Here, the carries C₀, C₁ and C₂ of the bits are calculated in parallel from the initial carry C₁ and the carry generation function G(3:0) and the carry propagation function P(3:0) obtained by the carry generation function and carry propagation function generating unit 11. Since the conventional carry propagation adder obtains a carry for each bit sequentially, the delay due to carry propagation is caused inevitably.

The add operation unit 13 implements the mathematical expression of the sum Si represented in Equation 3 by exclusive OR elements 131, 132, 133 and 134. The carry propagation functions P₀, P₁, P₂ and P₃ obtained by the carry propagation function carry generation function and carry propagation function generating unit 11, the carries C₀, C₁ and C₂ obtained by the carry generating unit 12, and the initial carry C₁ are used as the input signals for the exclusive OR elements 131, 132, 133 and 134.

The add operation for more than 16-bit number can be implemented by combining at least more than one 16-bit carry look-ahead adders. The propagation delay time caused by the logic gate elements of such a carry look-ahead adder can be represented Equation 6.

Equation 6
Total propagation time=(4*┌log_{b} n┐)T_{G}
where “┌A┐” is read “ceiling” and implies rounding up A to one decimal place to make A an integer.

In the equation 6, b is the number of unit adders constituting the entire adder. In the case of the 16-bit carry look-ahead adder shown in FIG. 1, b=4. The n is the number of bits of the input signals processed in the unit adder. Supposing that the propagation delay of each of the logic gate elements of the entire adder is 1 T_{G} and the area of the one logic gate element is 1 A_{G}, the relation between the propagation delay and the are a of the one logic gate element according to the number of bits processed in the entire adder is shown in Table 1.

TABLE 1

| The number of bits | Propagation delay | Area of entire gate |
|---|---|---|
| of a unit adder | (T_{G}) | elements |
| 4 bits | 4 | 26 |
| 16 bits | 8 | 115 |
| 64 bits | 12 | 471 |
| 256 bits | 16 | 1895 |

Referring to Table 1, if the number of input bits of the unit adder increases fourfold, the propagation delay increases by 4 T_{G} but the area which the entire gate elements occupy increases by four times. Accordingly, in the application that uses either a unit adder of the big number of bits or a plurality of unit adders, it is more effective to reduce the area rather than to reduce propagation delay time of the unit adder.

### SUMMARY OF THE INVENTION

Accordingly, the present invention is directed to a carry look-ahead adder having a reduced area that substantially obviates one or more problems due to limitations and disadvantages of the related art.

It is an object of the present invention to provide a carry look-ahead adder of reducing the number of logic gate elements and area of the whole adder by simplifying the carry generation block of unit adder.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a carry look-ahead adder having a reduced area, comprises a plurality of unit adders for receiving two input signals represented by n bits, performing add operation, outputting add operation result of n bits, and generating and outputting a carry generation function and a carry propagation function by using the two input signals so as to calculate an initial carry of a next stage; and a carry look-ahead generating unit for receiving the initial carry and a carry generation function and a carry propagation function outputted from each of the plurality of unit adders, and generating initial carries for the unit adders excluding a first unit adder and an initial carry generation function and an initial carry propagation function provided to an adder of the next stage, wherein each of the unit adders calculates a carry for each bit of the input signal sequentially when generating internal carries.

Each of the unit adders of the carry look-ahead adder comprises: a carry generation function and carry propagation function generating unit for generating a carry generation function and carry propagation function to be used in each of the unit adders by performing predetermined logic operation on the two input signals; a carry generating unit for calculating a carry of each bit of the input signals sequentially by using a carry of a neighboring previous bit; and an add operation unit for performs add operation and generating an add operation result of n bits by using the carry propagation function obtained by the carry generation function and carry propagation function generating unit, a carry obtained by the carry generating unit, and an initial carry.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an overall circuit of a general 16-bit carry look-ahead adder;

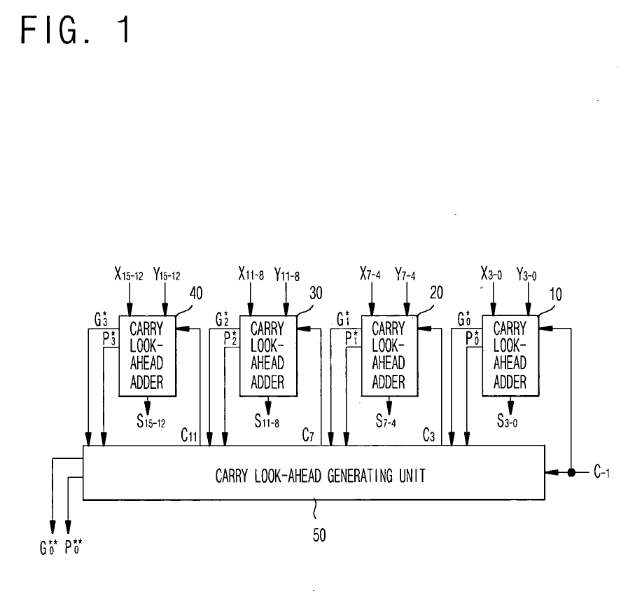

FIG. 2 illustrates one of the carry look-ahead adders shown in FIG. 1 in detail;

FIG. 3 illustrates an overall circuit of a 16-bit carry look-ahead adder according to an embodiment of the present invention;

FIG. 4 illustrates one of the carry look-ahead adders shown in FIG. 3 in detail; and

FIG. 5 illustrates a carry look-ahead generating unit shown in FIG. 3 in detail.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

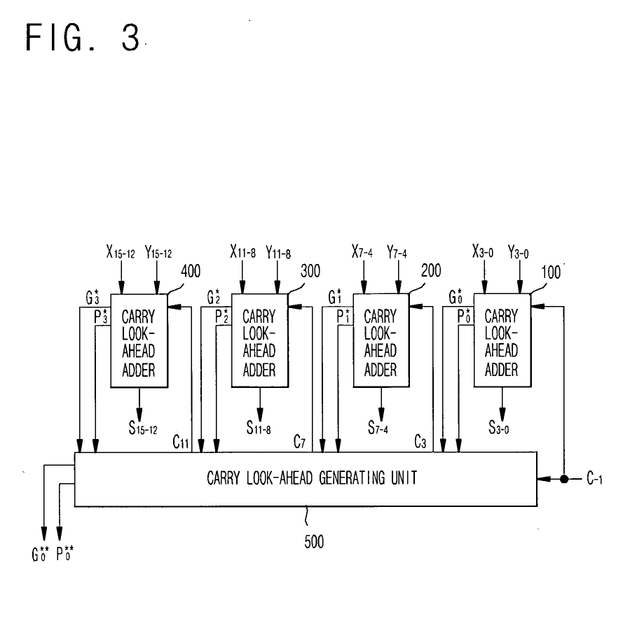

FIG. 3 illustrates an overall circuit of a 16-bit carry look-ahead adder according to an embodiment of the present invention. As shown in FIG. 3, the 16-bit carry look-ahead adder of this embodiment includes four 4-bit carry look-ahead adders 100, 200, 300 and 400 and a carry look-ahead generating unit 500. In the embodiment of the present invention, the 16-bit carry look-ahead adder including the four 4-bit carry look-ahead adders 100, 200, 300 and 400 is disclosed but the scope of the present invention is not bounded to the embodiment. In other words, according to description of this specification, the skilled in the art can construct an entire adder by combining a few unit adders in accordance with the number of bits of the signal requiring for add operation. As described above, the reason why the four 4-bit adders are used for 16-bit add operation is that, if the number of input bits increases, it is advantageous to divide the entire 16-bit adder into a few unit blocks because of the limitation of the number of inputs of internal logic gate elements.

The carry look-ahead adders 100, 200, 300 and 400 receive two input signals X and Y represented by 4 bits and performs add operation. The carry look-ahead adders 100, 200, 300 and 400 output 4-bit add operation results S₃₋₀, S₇₋₄, S₁₁₋₈ and S₁₅₋₁₂ respectively. At the same time, the carry look-ahead adders 100, 200, 300 and 400 generate and output carry generation functions G₀*, G₁*, G₂* and G₃* and carry propagation functions P₀*, P₁*, P₂* and P₃* respectively.

The carry look-ahead generating unit 500 receives initial carry C₋₁, the carry generation functions G₀*, G₁*, G₂* and G₃* outputted from the carry look-ahead adders 100, 200, 300 and 400 and the carry propagation functions P₀*, P₁*, P₂* and P₃*, and generate initial carries C₃, C₇ and C₁₁ for the carry look-ahead adder 200, 300 and 400, and a carry generation function G₀** and a carry propagation functions P₀** that are to be provided to the 16-bit adder of the next stage (if the 16-bit adder is connected as the next stage). The initial carries C₃, C₇ and C₁₁ are provided to the carry look-ahead adders 200, 300 and 400 respectively and used in add operation of the corresponding carry look-ahead adders 200, 300 and 400. Also, the initial carry C₋₁ inputted to the first 4-bit carry look-ahead adder 100 and the carry look-ahead generating unit 500 is provided from a 16-bit adder of the previous stage when the adder is an adder made of a plurality of 16-bit adders but the initial carry C₋₁ is a value preset by a user when the entire adder is configured of a 16-bit carry look-ahead adder separately.

The carry generation function Gᵢ* and the carry propagation function Pᵢ* can be represented as Equation 5 described above. However, carries Cᵢ is calculated through Equation 7 in the 4-bit carry look-ahead adders 100, 200, 300 and 400 according to the embodiment of the present invention.

Equation 7
C₀=G₀+C₋₁·P₀
C₁=G₁+C₀·P₁
C₂=G₂+C₁·P₂
C₃=G₀*+C₋₁·P₀*
C₄=G₄+C₃·P₄
C₅=G₅+C₄·P₅
C₆=G₆+C₅·P₆
C₇=G₁*+C₃·P₁*
C₈=G₈+C₇·P₈
C₉=G₉+C₈·P₉
C₁₀=G₁₀+C₉·P₁₀
C₁₁=G₂*+C₇·P₂*
C₁₂=G₁₂+C₁₁·P₁₂
C₁₃=G₁₃+C₁₂·P₁₃
C₁₄=G₁₄+G₁₃·P₁₄

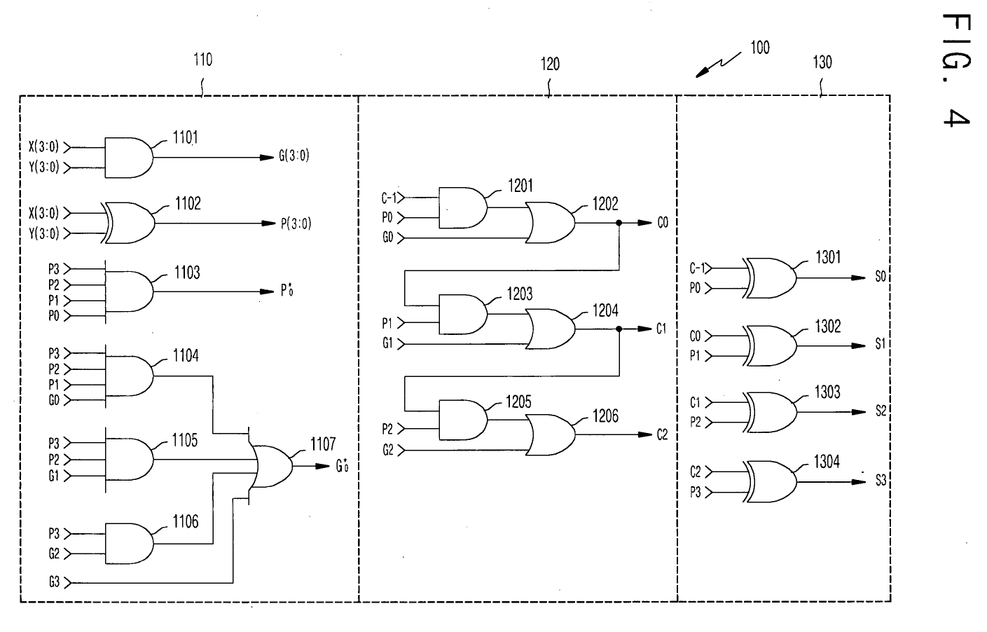

Referring to Equation 7, the 4-bit carry look-ahead adders 100, 200, 300 and 400 according to the embodiment of the present invention calculate carries sequentially so that carry propagation delay is allowed a little but the equation for generating carries is simplified. The number of the logic gate elements can be reduced. The 4-bit carry look-ahead adder 100 in which the carry generating unit is implemented using Equation 7 is illustrated in FIG. 4.

The 4-bit carry look-ahead adder 100 illustrated in FIG. 4 receives two input signals X₃₋₀ and Y₃₋₀ of 4 bits and an initial carry input C₋₁, and calculates and outputs a 4-bit sum S₃₋₀, a carry generation function G₀* and a carry propagation function P₀*.

In other words, the 4-bit carry look-ahead adder 100 is configured of logic gate circuits such that can calculate the carry generation function G(3:0) and the carry propagation function P(3:0) used in the adder by using Equation 2, calculate the carries C₀, C₁ and C₂ and the carry generation function G₀* and the carry propagation function P₀* that are to be provided to the 4-bit carry look-ahead adder 200 of the next stage by using Equation 7, and calculate the 4-bit sum S₀, S₁, S₂ and S₄ by using Equation 3.

The 4-bit carry look-ahead adder 100 includes a carry generation function and carry propagation function generating unit 110, a carry generating unit 120 and an add operation unit 130.

The carry generation function and carry propagation function generating unit 110 receives 4-bit input signals X(3:0) and Y(3:0), performs AND operation and exclusive OR operation by using an AND element 1101 and an exclusive OR element 1102 respectively, and generates a carry generation function G(3:0) and a carry propagation function P(3:0) to be used in the carry look-ahead adder 100. The mathematical expressions of the carry generation function G₀* and a carry propagation function P₀* that are described in Equation 5 and provided to 4-bit carry look-ahead adder 200 of the next stage are implemented by hardware such as four AND elements 1103, 1104, 1105 and 1106 and an OR element 1107.

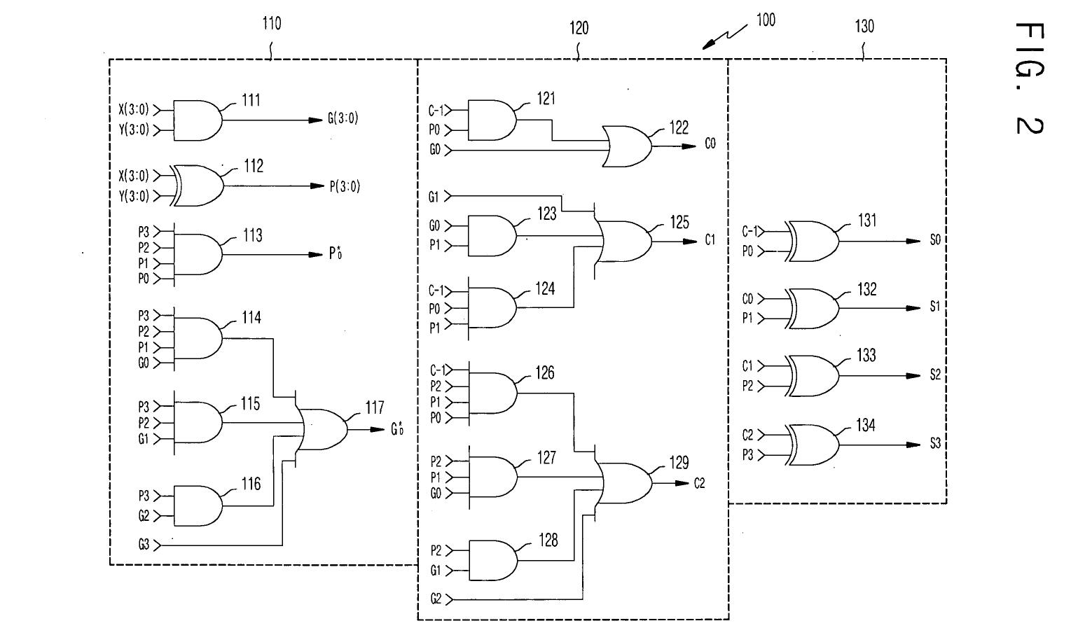

The mathematical expression of carries C₀, C_{1 and C}₂ represented in Equation 7 is implemented by AND elements 1201, 1203 and 1205 and OR elements 1202, 1204 and 1206 of the carry generating unit 120. Here, the carry C₀ is calculated from the initial carry C₋₁ and the carry generation function G(3:0) and the carry propagation function P(3:0) obtained by the carry generation function and carry propagation function generating unit 110 as in the conventional carry look-ahead adder shown in FIG. 2. However, the remaining carries C_{1 and C}₂ are obtained by obtaining the previous bits, for example, C₀ for C₁ and C₁ for C₂ and using the obtained previous bits. In other words, the carry look-ahead adder according to the embodiment of the present invention is characterized in that the carry for each bit is calculated sequentially using a carry of the previous bit. In this case, since the carry of each bit is calculated sequentially, the delay caused by the logic gate circuit is inevitable. Instead, the circuit configuration of the carry generating unit 120 shown in FIG. 4 can be simplified more than the carry generating unit of the conventional carry look-ahead adder and the number of logic gate elements can be reduced so much. As the number of bits of the input signal for the carry look-ahead adder increases, the simplicity of the carry generating unit is improved further.

The add operation unit 130 shown in FIG. 4 implements the mathematical expression of the sum Si represented in Equation 3 by exclusive OR elements 1301, 1302, 1303 and 1304. The carry propagation functions P₀, P₁, P₂ and P₃ obtained by the carry propagation function carry generation function and carry propagation function generating unit 110, the carries C₀, C₁ and C₂ obtained by the carry generating unit 120, and the initial carry C₋₁ are used as the input signals for the exclusive OR elements 1301, 1302, 1303 and 1304. The exclusive OR elements 1301, 1302, 1303 and 1304 perform exclusive OR operation on the corresponding input signals and generate 4-bit sum S₃₋₀.

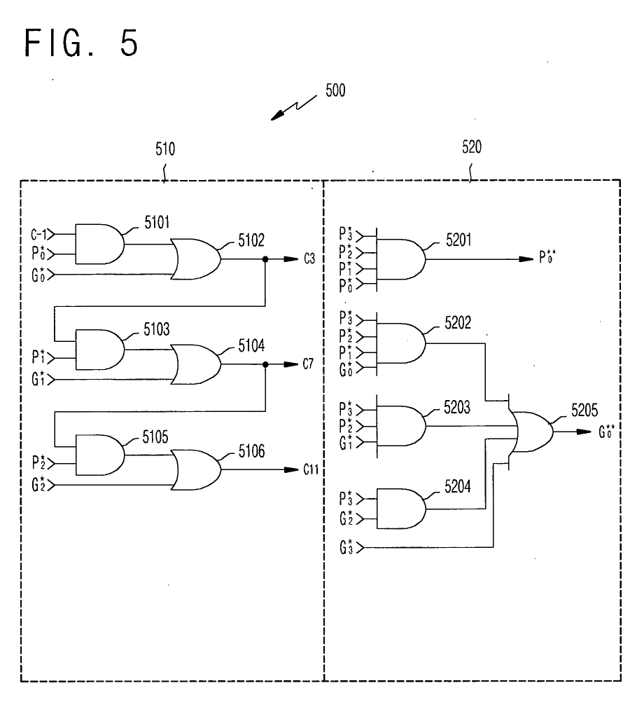

FIG. 5 illustrates a carry look-ahead generating unit 500 shown in FIG. 3 in detail.

The carry look-ahead generating unit 500 shown in FIG. 5 includes an initial carry generating unit 510 and an initial carry generation function and carry propagation function generating unit 520. The initial carry generating unit 510 receives carry generation functions G₀*, G₁*, G₂* and G₃* and carry propagation functions P₀*, P₁*, P₂* and P₃* from 4-bit carry look-ahead adders 100, 200, 300 and 400, and generating initial carries C₃, C₇ and C₁₁ to be inputted to the carry look-ahead adders 200, 300 and 400. The mathematical expressions to calculate the initial carries C3, C7 and C11 in Equation 7 are implemented as the initial carry generating unit 510 shown in FIG. 5 by ADD elements 5101, 5103 and 5105 and OR elements 5102, 5104 and 5106. The initial carry generation function and carry propagation function generating unit 520 is used when at least two 16-bit adders are combined. The initial carry generation function and carry propagation function generating unit 520 receives carry generation functions G₀*, G₁*, G₂* and G₃* and carry propagation functions P₀*, P₁*, P₂* and P₃* from the 4-bit carry look-ahead adders 100, 200, 300 and 400, and generates an initial carry generation function G₀** and an initial carry propagation function P₀** for the 16-bit adder of the neighboring next stage. The initial carry generation function and carry propagation function generating unit 520 is a logic gate circuit that implements the mathematical expressions representing the initial carry generation function G₀** and an initial carry propagation function P₀** in Equation 5 by using ADD elements 5201, 5202, 5203 and 5204 and an OR element 5205.

The carry propagation delay of the carry look-ahead adder according to the present invention and area ratio of a logic gate circuit will be disclosed in Table 2. In Table 2, b is the number of unit adders constituting the entire adder, 1 T_{G} is the propagation delay of each of the logic gate elements of the entire adder and 1 A_{G} is the area of the one logic gate element. The area ratio means the area ratio of a logic gate circuit of the carry look-ahead adder of the present invention to that of the conventional carry look-ahead adder.

TABLE 2

| The number | | Ratio of | Area of | |
|---|---|---|---|---|
| of bits of a | Propagation | propagation | entire gate | |
| unit adder | delay (T_{G}) | delay | elements | Area ratio |
| 4 bits | 6 | 1.50 | 23 | 0.885 |
| 16 bits | 10 | 1.25 | 103 | 0.895 |
| 64 bits | 14 | 1.116 | 423 | 0.898 |
| 256 bits | 18 | 1.125 | 1703 | 0.898 |

Referring to Table 2, the carry generating unit of the carry look-ahead adder according to the embodiment of the present invention is configured to be simple so that the area of a logic gate circuit is reduced by at least 10% compared with the conventional carry look-ahead adder without relation to the number of bits of input signal for the adder.

As described above, the carry look-ahead adder according to the embodiment of the present invention calculates carry of each bit sequentially not by using any carry generation function or any carry propagation function but by using previous bit when generating an internal carry in the adder, so that propagation delay is allowed a little but the logic gate circuit can be simplified.

It will be apparent to those skilled in the art that various modifications and variations can be made in the present invention. Thus, it is intended that the present invention covers the modifications and variations of this invention provided they come within the scope of the appended claims and their equivalents.

1. A carry look-ahead adder having a reduced area, comprising:
a plurality of unit adders for receiving two input signals represented by n bits, performing add operation, outputting add operation result of n bits, and generating and outputting a carry generation function and a carry propagation function by using the two input signals so as to calculate an initial carry of a next stage; and
a carry look-ahead generating unit for receiving the initial carry and a carry generation function and a carry propagation function outputted from each of the plurality of unit adders, and generating initial carries for the unit adders excluding a first unit adder and an initial carry generation function and an initial carry propagation function provided to an adder of the next stage,
wherein each of the unit adders calculates a carry for each bit of the input signal sequentially when generating internal carries.

2. The carry look-ahead adder according to claim 1, wherein each of the unit adders comprises:
a carry generation function and carry propagation function generating unit for generating a carry generation function and carry propagation function to be used in each of the unit adders by performing predetermined logic operation on the two input signals;
a carry generating unit for calculating a carry of each bit of the input signals sequentially by using a carry of a neighboring previous bit; and
an add operation unit for performs add operation and generating an add operation result of n bits by using the carry propagation function obtained by the carry generation function and carry propagation function generating unit, a carry obtained by the carry generating unit, and an initial carry.

3. The carry look-ahead adder according to claim 2, wherein the carry generation function and carry propagation function generating unit calculates the carry generation function Gᵢ and the carry propagation function Pᵢ based on following equation:
Gᵢ=Xᵢ·Yᵢ
Pᵢ=Xᵢ⊙Yᵢ
where Xᵢ and Yᵢ (i is integers such as 0, 1, 2, . . . ) are the two input signals, Gᵢ is the carry generation function, Pᵢ is the carry propagation function, “·” implies logic OR and “⊙” implies exclusive OR.

4. The carry look-ahead adder according to claim 2, wherein the n bits is 4 bits, and a carry of each bit of the carry generating unit is calculated based on following equation:
C₀=G₀+C₋₁·P₀
C₁=G₁+C₀·P₁
C₂=G₂+C₁·P₂
C₃=G₀*+C₋₁·P₀*
where Gᵢ (i=0, 1, 2, 3) is the carry generation function, Pᵢ (i=0, 1, 2, 3) is the carry propagation function, Gᵢ* (i=0, 1, 2, 3) is the initial carry generation function, Pᵢ* (i=0, 1, 2, 3) is the initial carry propagation function, C₋₁ is the initial carry, and “·” implies logic OR.

5. The carry look-ahead adder according to claim 2, wherein the add operation result Sᵢ of the add operation unit is calculated based on following equation:
Sᵢ=PᵢCᵢ₋₁
where Sᵢ is the add operation result, Pᵢ (i is integers such as 0, 1, 2, . . . ) is the carry propagation function, Cᵢ (i is integers such as 0, 1, 2, . . . ) is the carry, and “⊙” implies exclusive OR.

6. The carry look-ahead adder according to claim 2, wherein the n bits is 4 bits, the number of the unit adder is 4, the carry look-ahead adder performs add operation on two input signals of 16 bits.
